(19) United States
(12) Patent Application Publication
(10) Pub. No.: US 2005/0223214 A1
(43) Pub. Date: Oct. 6, 2005

(54) Security measures in a reconfigurable communication system

(75) Inventor: William C. DeLeeuw, Portland, OR (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/813,058

(22) Filed: Mar. 31, 2004

(51) Int. Cl. H04L 9/00

(52) U.S. Cl. 713/151

(57) ABSTRACT

In a reconfigurable communication system, transmission and configuration data may be screened for authorization to provide security, to prevent unauthorized forms of transmission.

### BACKGROUND OF THE INVENTION

The number of different communication protocols, for hardwired and/or wireless communications, has burgeoned. As a result reconfigurable communication systems have been proposed, in which multiple protocols may be supported for communicating. Such reconfigurable communication systems may also include controllable and/or reconfigurable elements for performing physical-layer transmission. Physical transmission, particularly by wireless means, may be regulated by one or more regulatory authorities. To meet requirements of such regulatory authorities, one may need to ensure that the elements performing physical-layer transmission can not be reconfigured such that they may violate regulatory guidelines, either intentionally or unintentionally.

### BRIEF DESCRIPTION OF THE DRAWINGS

Embodiments of the invention will now be described in conjunction with the accompanying drawings, in which:

FIGS. 1A and 1B depict conceptual block diagrams of reconfigurable communication systems in which may be embodied some embodiments of the invention;

FIG. 2 depicts a conceptual block diagram of a portion of a reconfigurable communication system showing data flow according to some embodiments of the invention;

FIG. 3 depicts a conceptual block diagram of a component of FIG. 2, according to some embodiments of the invention;

FIGS. 4A, 4B, and 4C conceptually depict data units that may be used in some embodiments of the invention;

FIG. 5 depicts a flowchart outlining a process according to some embodiments of the invention; and

FIG. 6 depicts a conceptual block diagram of a system that may be used in implementing some embodiments of the invention.

### DETAILED DESCRIPTION OF VARIOUS EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-accessible medium, which may be read and executed by a computing platform to perform the operations described herein. A machine-accessible medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

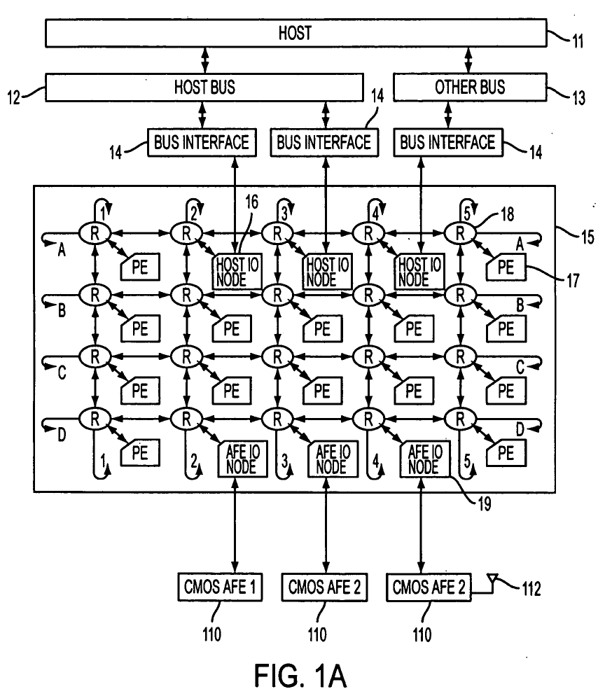

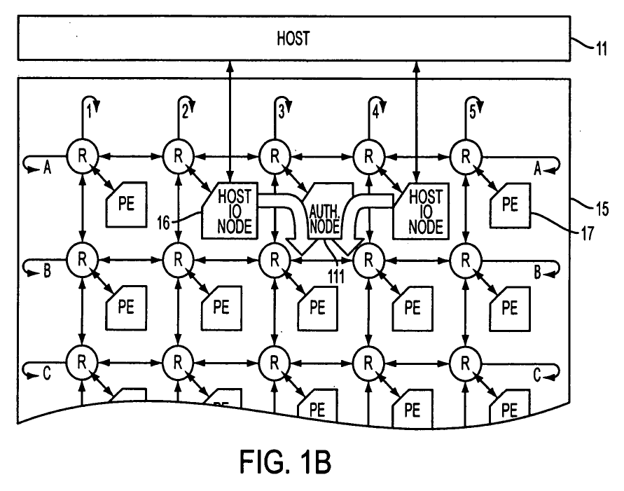

FIG. 1A depicts a conceptual block diagram of a reconfigurable communication system in which some embodiments of the invention may be embodied. A reconfigurable communication system 15 may comprise a network of interconnected nodes. The interconnected nodes may include, but are not limited to, protocol elements (PEs), such as node 17, host input/output (IO) nodes, such as node 16, and analog front-end (AFE) IO nodes, such as node 19. The nodes may be interconnected by means of routing nodes (R), such as node 18. A host IO node, such as node 16, may be coupled to a bus interface 14. A bus interface 14 may be coupled to a host bus 12 or other bus 13, which, in turn, m a y be coupled to a host 11. A host 11 may, for example, comprise a computing platform, but is not limited thereto. An AFE IO node, such as node 19, may be coupled to an AFE 110, which may be implemented in complementary metal-oxide-semiconductor (CMOS) technology (as shown in FIG. 1A), but which may be otherwise implemented, as well. An AFE 110 may be used to interface with a communication medium, and it may be coupled to further transmit and/or receive equipment and/or to an antenna 112 or other appropriate transducer, where such an antenna may be a monopole, dipole, loop, planar antenna, reflector, array, etc.

FIG. 1B shows a portion of FIG. 1A in further detail and introduces another type of node not shown in FIG. 1A, an authentication node 111, which may be found in some embodiments of the invention. Authentication node 111 may be used in implementing security features according to embodiments of the invention. A reconfigurable communication system 15 may also contain multiple authentication nodes 111.

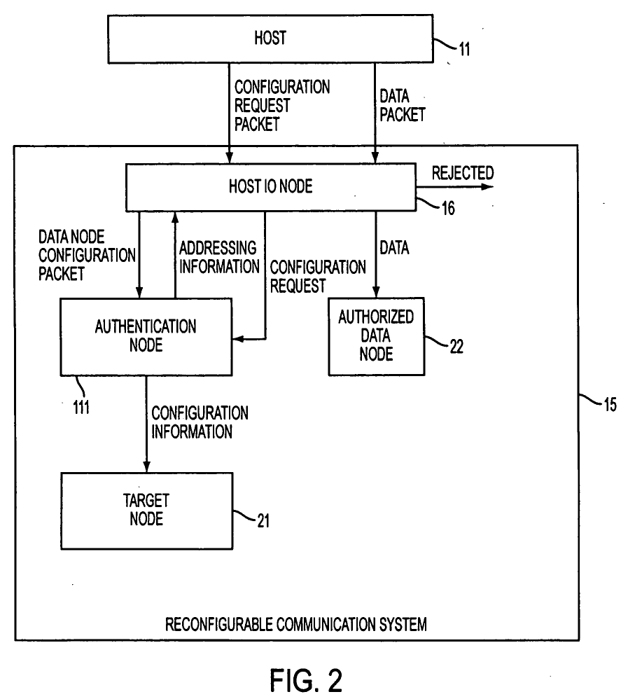

FIG. 2 shows a partial conceptual block diagram showing information flow in accordance with some embodiments of the invention. The embodiment of FIG. 2 may deal with at least two types of information: configuration request information and actual data for transmission. The former type of information may result in the reconfiguration of all or part of a node of reconfigurable communication system 15, while the latter, while not affecting the configuration of a node, may affect transmission characteristics of a generated physical signal. The features shown in FIG. 2 may prevent unauthorized users from inserting spurious information of either type into reconfigurable communication system 15.

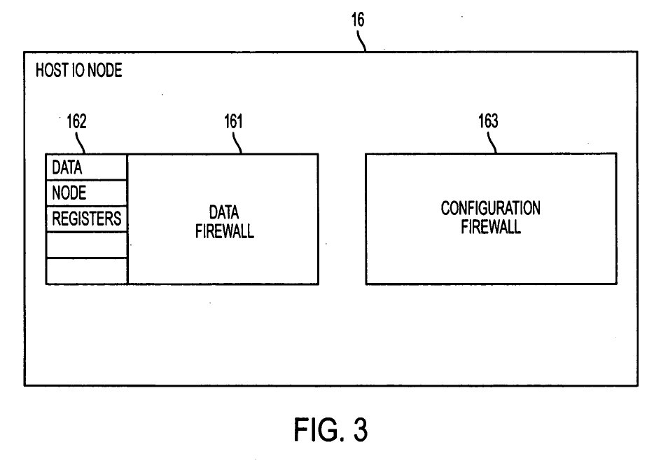

In the case of configuration request information, a host 11 may send a configuration request packet, that may be intended for a programmable target element 21, to the reconfigurable communication system 15, where it may be processed by a host IO node 16. Host IO node 16 may contain a configuration firewall 163, as shown in FIG. 3, which may ensure that all configuration request packets are directed to an authentication node 111. This may be done by scanning each configuration request packet to make sure that it is destined for an authentication node 111 and, if not, changing its destination so that it is destined for an authentication node 111 (alternatively, other security measures may be taken, for example, the configuration request packet may be discarded, or the system may be reset). Authentication node 111 may be responsible for verifying that the configuration request packet is valid (i.e., authorized). If not valid, authentication node 111 may discard the packet or take other security measures; if it is determined to be valid, authentication node 111 may forward configuration information contained in the configuration request packet to the target node 21.

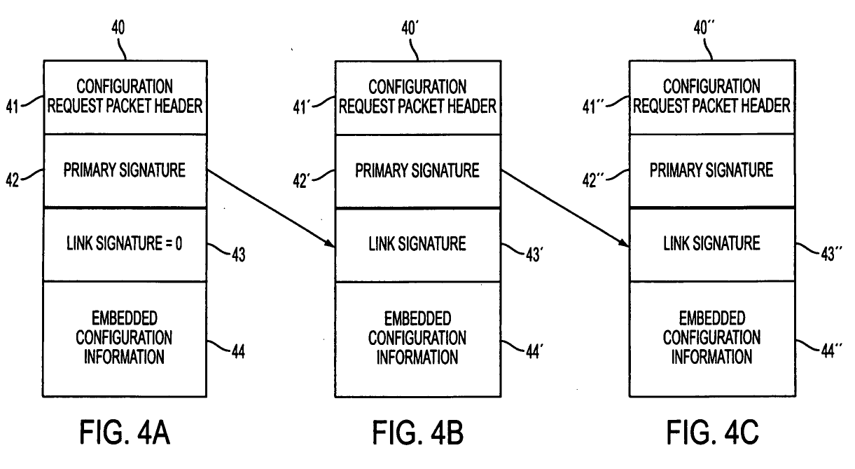

FIGS. 4A-4C show configuration request packets 40, 40′, 40″ as may be used in some embodiments of the invention. A configuration request packet 40, 40′, 40″ may include a configuration request packet header 41, 41′, 41″, a primary signature 42, 42′, 42″, a link signature 43, 43′, 43″, and embedded configuration information 44, 44′, 44″. In some embodiments of the invention, configuration request packet header 41, 41′, 41″ may contain addressing information that may identify an authentication node 111 as an initial destination and a target node 21 as an intended destination. Embedded configuration information 44, 44′, 44″ may contain actual information that may be used to configure a programmable target node 21. Other portions of configuration request packets 40, 40′, 40″ may be related to security provisions (for example, but not limited to, encryption).

In particular, some embodiments of the invention may utilize primary signatures 42, 42′, 42″ and link signatures 43, 43′, 43″ as parts of configuration request packets 40, 40′, 40″, and these may form a two-tiered authentication structure. Configuration request packets 40, 40′, 40″ may comprise a set such that no arbitrary packet within the set may be added, removed, or modified without re-signing all packets in the set. A “signature” is some sort of security portion of the configuration request packet 40, 40′, 40″ and may be formed by a trusted authority using a certifier program, for example, using the Rivest-Shamir-Adelman (RSA) algorithm, the RSA digital signature algorithm (RDSA), a hashing algorithm, or other suitable encoding and/or encryption method or combination of methods. A trusted authority (e.g., user or machine) may create a primary signature 42, 42′, 42″ based on a link signature 43, 43′, 43″ and the packet payload 44, 44′, 44″. Note that while the latter portion 44, 44′, 44″ may be encrypted, it need not be encrypted. Also note that, while as shown in FIG. 4A, the link signature of an initial configuration request packet 40 may be zero or some other initial value, link signatures 43′ and 43″ of subsequent packets 40′ and 40″, respectively, in the set may contain copies of the primary signatures 42 and 42′, respectively, of their preceding packets (40 and 40′, respectively).

Given the above-described packet structure, authentication node 111 may examine both the primary signature 42, 42′, 42″ and the link signature 43, 43′, 43″ of each configuration request packet. Authentication node 111 may check to see that each primary signature 42, 42′, 42″ is valid and that each link signature 43, 43′, 43″ is a copy or derivative of the previous primary signature (with the above-noted exception for the initial packet). In a case in which authentication node 111 determines that one or both signatures are not as expected, the configuration attempt (i.e., by the configuration request packets) may be aborted, and the programmable target device 21 may be reset (for example, but not necessarily, to its previous configuration or to a default configuration).

While the above discussion describes the link signatures 43, 43′, 43″ as being based on a previous primary signature 42, 42′, 42″, the invention need not be thusly limited. For example, in some embodiments, a link signature 43, 43′, 43″ may be a copy or derivative of a subsequent primary signature 42, 42′, 42″ (in such a case, the final packet in the set may have the “initial” value for its link signature). In general, link signatures 43, 43′, 43″ may be copies or derivatives of primary signatures 42, 42′, 42″ according to some predetermined ordering, to permit cross-checking of link and primary signatures.

Returning to FIG. 2, as discussed above, a second type of information of concern is actual data for transmission. The concern here may be that some unauthorized entity may attempt to introduce data for transmission by the reconfigurable communication system 15, and that the introduced data may cause undesirable transmission effects (for example, but not limited to, power levels and spectral shaping). The reconfigurable communication system 15 may deal with this by means of a pre-authentication scheme.

Prior to presenting actual data for transmission, an authorized host 11 may submit a data node configuration packet to the reconfigurable communication system 15. A data node configuration packet is a type of configuration request packet containing data node addressing information and targeting a host IO node 16. Within the reconfigurable communication system 15, the data node configuration packet may be sent to authorization node 111. Authorization node 111 may verify whether or not the data node configuration packet is signed by an authorized entity. If not, it may be discarded, or alternative security measures, such as, but not limited to, resetting the system, may be taken. If the data node configuration packet is signed by an authorized entity, authentication node 111 may forward at least addressing information from the data node configuration packet to a host IO node 16. In some embodiments, this is done by means of an internal (secure) interface between authentication node 111 and host IO node 16, as shown.

As shown in FIG. 3, a host IO node 16 may further include a data firewall 161. Note that a reconfigurable communication system 15 may employ multiple types of host IO nodes 16, where some may deal with both transmission data and configuration information (as may occur in the example shown in FIG. 3) and thus may have both firewalls 161 and 163, and some may deal with one or the other and may include either data firewall 161 or configuration firewall 163. Address information received from authentication node 111 may be received by a host IO node 16 and may be used to configure data firewall 161 to permit data from the authorized entity to be sent to particular nodes in reconfigurable communication system 15. In one embodiment, the data firewall 161 may include data node registers 162 for storing information on valid nodes to which an authorized entity may send data for transmission. In some embodiments, data node registers 162 may comprise memory separate from and accessed by the data firewall 161. Furthermore, such memory may be used by only a single data firewall 161 of a single host IO node 16, or it may be shared by more than one data firewall and/or host IO node.

Once data firewall 161 has been configured using address information, data firewall 161 may handle data packets. A data packet may be sent from a host 11 to a host IO node 16, where it may be examined by a data firewall 161. If the data packet is addressed to an authorized data node 22, the data may be forwarded to the node 22 by host IO node 16. If not, host IO node 16 may reject and discard the data packet, or may take alternative security measures, such as, but not limited to, resetting the system.

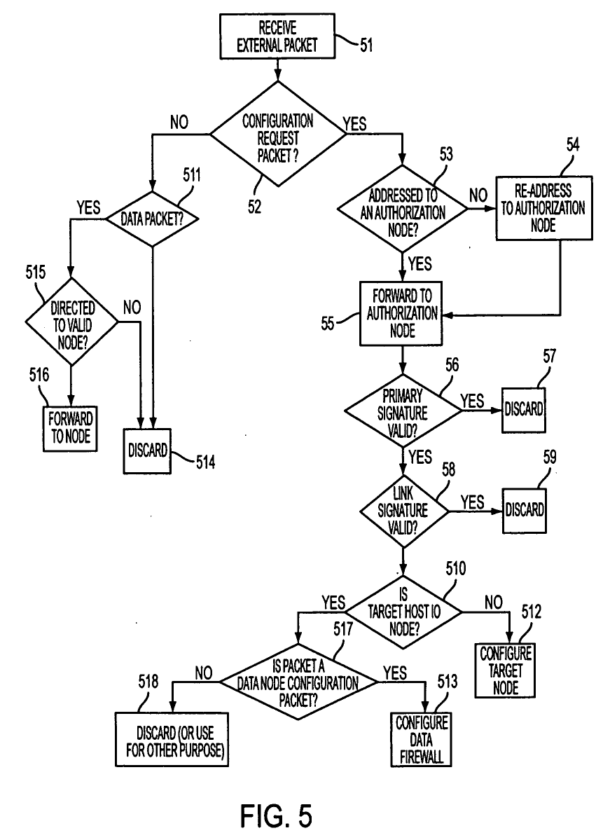

FIG. 5 depicts a process that may be carried out according to some embodiments of the invention. When a packet is received by a reconfigurable communication system 15 from an external source (e.g., a host 11), it may be sent to a host IO node 16, where it may be determined 52 whether or not the packet is a configuration request packet. If it is a configuration request packet, the process may proceed to block 53 and may determine if the configuration request packet is addressed to an authentication node 111. If so, then it may be sent 55 to such an authentication node 111; if not, it may be re-addressed to an authentication node 111 and then forwarded 55 (in an alternative embodiment, not shown in FIG. 5, the configuration request packet may be discarded, rather than re-addressed, in which case the process would end, or other security measures may be taken). The process may then proceed to block 56 and may test the primary signature of the configuration request packet. If the primary signature is found to be invalid, the configuration request packet may be discarded 57 (or other alternative security measures taken). If the primary signature is found to be valid, the link signature of the configuration request packet may be tested at block 58. As with the primary signature, if the link signature is found to be invalid, the configuration request packet may be discarded 59 (or other alternative security measures may be taken). Otherwise, the process may continue with block 510 and may determine if the target of the configuration request packet is a host IO node. If the target is not a host IO node, then the configuration information may be sent to a target node 21, which may then be configured 512. If the target is a host IO mode, then the configuration request packet may be a data node configuration packet, and this inquiry may be made at block 517. If the configuration request packet is a data node configuration packet, the configuration information may be sent back to host IO node 16, and the data firewall may be configured 513. Otherwise, if the configuration request packet is not a data node configuration packet, it may be discarded or may be used for a purpose other than data node configuration 518.

If the packet is determined not to be a configuration request packet (at block 52), it may be treated by the process of the left side of FIG. 5. The process may first determine 511 whether or not the packet is a data packet. If it is determined to be such a data packet, the process may continue with block 515 and may determine if the data packet is directed to a valid (authorized) node; this may be done, for example, by the data firewall 161 of a host IO node 16, as shown in FIG. 3. If the data packet is determined to be directed to a valid node, the process may continue with block 516 and may forward the data to that node (e.g., node 22 in FIG. 2). Otherwise, the data packet may be discarded 514 (or, in an alternative embodiment, the system may be reset, and/or other security measures taken). If the packet is determined not to be a data packet (in block 511), the process may continue with block 514 and may discard the packet (or, again, in an alternative embodiment, the system may be reset, and/or other security measures taken).

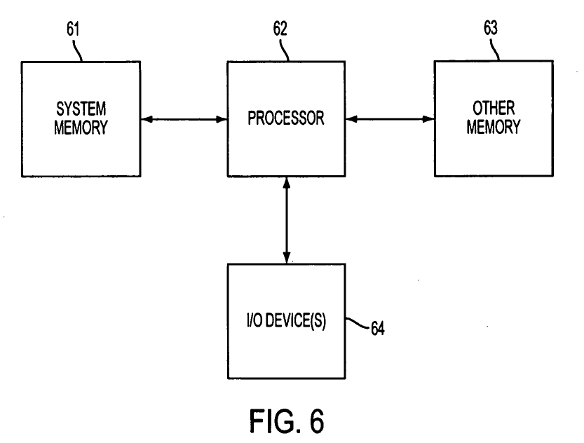

Some embodiments of the invention, as discussed above, may be embodied in the form of software instructions on a machine-accessible medium. Such an embodiment is illustrated in FIG. 6. The computer system of FIG. 6 may include at least one processor 62, with associated system memory 61, which may store, for example, operating system software and the like. The system may further include additional memory 63, which may, for example, include software instructions to perform various applications. System memory 61 and additional memory 63 may comprise separate memory devices, a single shared memory device, or a combination of separate and shared memory devices. The system may also include one or more input/output (I/O) devices 64, for example (but not limited to), keyboard, mouse, trackball, printer, display, network connection, etc. The present invention may be embodied as software instructions that may be stored in system memory 61 or in additional memory 63. Such software instructions may also be stored in removable or remote media (for example, but not limited to, compact disks, floppy disks, etc.), which may be read through an I/O device 64 (for example, but not limited to, a floppy disk drive). Furthermore, the software instructions may also be transmitted to the computer system via an I/O device 64, for example, a network connection; in such a case, a signal containing the software instructions may be considered to be a machine-accessible medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. An apparatus, comprising:
at least one reconfigurable processing device;
at least one authentication processing device; and
at least one interface processing device to be coupled to at least one of said reconfigurable processing device and said authentication processing device;
wherein the apparatus is adapted to forward information to configure at least one of said reconfigurable processing device and said interface processing device, received by said apparatus, to said authentication processing device to verify that the information came from an authorized source.

2. The apparatus according to claim 1, wherein said interface processing device comprises at least one of a data firewall and a configuration firewall.

3. The apparatus according to claim 2, wherein said interface processing device includes one or more data node registers to configure said data firewall to permit forwarding of data to at least one of said at least one reconfigurable processing device.

4. A system, comprising:
at least one reconfigurable processing device;
at least one authentication processing device;
at least one interface processing device to be coupled to at least one of said reconfigurable processing device and said authentication processing device;
at least one analog front-end device to be coupled to at least one of said at least one reconfigurable processing device; and
an antenna selected from the group consisting of monopole antennas, dipole antennas, antenna arrays, loop antennas, planar antennas, and reflector-type antennas.
wherein the system is adapted to forward information to configure at least one of said reconfigurable processing device and said interface processing device, received by the system, to said authentication processing device to verify that the information came from an authorized source.

5. The system according to claim 4, further comprising:
at least one host device to be coupled to said at least one interface processing device, the at least one host device adapted to provide information to be processed by at least one of said at least one reconfigurable processing device.

6. The system according to claim 4, further comprising:
at least one analog front-end interface device to couple between at least one of said at least one reconfigurable processing device and said at least one analog front-end device.

7. A method, comprising:
processing received information with a processing device specified by said received information if said received information comprises data and if the processing device is authorized to process said received information; and
performing an authentication process on said received information if said received information does not comprise data for transmission.

8. The method according to claim 7, wherein said performing an authentication process comprises:
forwarding said received information to an authentication device if said received information comprises a request to authorize one or more processing devices to process received information.

9. The method according to claim 8, wherein said performing an authentication process further comprises:
forwarding at least a portion of said received information to a received information interface device; and
configuring said received information interface device based at least in part on said at least a portion of said received information.

10. The method according to claim 7, wherein said performing an authentication process comprises:
verifying that said received information is addressed to an authentication processing device if said received information comprises processing device configuration information; and
taking security measures if said received information is not addressed to an authentication processing device.

11. The method according to claim 10, wherein said taking security measures comprises:
re-addressing said received information to an authentication processing device.

12. The method according to claim 10, wherein said taking security measures comprises at least one of discarding said received information or performing a reset operation.

13. The method according to claim 7, wherein, if said received information comprises processing device configuration information, said performing an authentication process comprises:
verifying a primary signature included in said received information; and
verifying a link signature included in said received information if said primary signature is valid.

14. The method according to claim 13, further comprising:
forwarding at least a portion of said received information to an intended processing device if said link signature is valid; and
using said at least a portion of said received information to configure said intended processing device.

15. A machine-accessible medium containing software code, which, when executed by a computing platform, causes said computing platform to perform a method comprising:
processing received information with a processing device specified by said received information if said received information comprises data and if the processing device is authorized to process said received information; and
performing an authentication process on said received information if said received information does not comprise data for transmission.

16. The machine-accessible medium according to claim 15, wherein said performing an authentication process comprises:
forwarding said received information to an authentication device if said received information comprises a request to authorize one or more processing devices to process received information.

17. The machine-accessible medium according to claim 16, wherein said performing an authentication process further comprises:
forwarding at least a portion of said received information to a received information interface device; and
configuring said received information interface device based at least in part on said at least a portion of said received information.

18. The machine-accessible medium according to claim 15, wherein said performing an authentication process comprises:
verifying that said received information is addressed to an authentication processing device if said received information comprises processing device configuration information; and
taking security measures if said received information is not addressed to an authentication processing device.

19. The machine-accessible medium according to claim 18, wherein said taking security measures comprises:
re-addressing said received information to an authentication processing device.

20. The machine-accessible medium according to claim 18, wherein said taking security measures comprises at least one of discarding said received information or performing a reset operation.

21. The machine-accessible medium according to claim 15, wherein, if said received information comprises processing device configuration information, said performing an authentication process comprises:
verifying a primary signature included in said received information; and
verifying a link signature included in said received information if said primary signature is valid.

22. The machine-accessible medium according to claim 21, further comprising software code that, when executed by said at least one computing platform, causes said at least one computing platform to further perform:
forwarding at least a portion of said received information to an intended processing device if said link signature is valid; and
using said at least a portion of said received information to configure said intended processing device.
